(19) United States
(12) Patent Application Publication
(10) Pub. No.: US 2002/0089309 A1
(43) Pub. Date: Jul. 11, 2002

(54) Method and device to generate electricity using existing traffic

(76) Inventor: Terry D. Kenney, Milpitas, CA (US)

Correspondence Address: Keith Kline, 14910 Bonner Court, Morgan Hill, CA, 95037-5925, US

(21) Appl. No.: 09/745,372

(22) Filed: Dec. 23, 2000

(51) Int. Cl. H02K 5/00

(52) U.S. Cl. 322/1

(57) ABSTRACT

A method of electrical power generation that utilizes traffic on existing roadways to generate the electricity. The method uses a electrical generation device installed beneath the roadbed. The electrical generation device includes a pressure plate covered with one or more protection layers which lie beneath the surface of the road. When a vehicle passes over the electrical generation device, the pressure plate is pushed downward by the weight of the vehicle. The downward displacement of the pressure plate is used to drive an electrical generator. The electricity generated is then transmitted to a power grid, or collected and stored until it is required by an end user.

### BACKGROUND OF THE INVENTION

1. Field of the Invention

The present invention relates generally to methods of electrical power generation, and more particularly is a method and device to generate electricity by using traffic on existing roadways to drive an electrical generator.

2. Description of the Prior Art

Modern technology requires a tremendous amount of electrical power to maintain its operation. Electricity generation is the single largest source of pollution in the world, outdistancing even the internal combustion engine. All common methods of electrical power generation suffer from significant shortcomings.

The burning of fossil fuels is the most widely used method of generating electricity. However, this method has the major drawback of severe environmental impact through air pollutant emission. Hydroelectric electricity generation eliminates the need to burn fuel, but it also creates a significant environmental impact on the water supply that drives the power generation equipment.

For these reasons, nuclear power plants have been developed. While nuclear power generation is in general an efficient and non-polluting method, the waste disposal difficulties and the threat of potentially disastrous accidents have kept this technology in a position of lessened importance.

One method of electricity generation that operates with no damage to the environment is wind power. However, operation of wind powered generators is of course subject to the availability of suitable wind. Therefore, wind power is typically used only as a secondary source of electrical power.

Accordingly, it is an object of the present invention to provide a method of electrical power generation that does not negatively impact the environment.

It is a further object of the present invention to provide a method that is dependable, and that can be used to produce significant percentages of electricity requirements.

### SUMMARY OF THE INVENTION

The present invention is a method of electrical power generation that utilizes traffic on existing roadways to generate the electricity. The method uses a electrical generation device installed beneath the roadbed. The electrical generation device includes a pressure plate covered with one or more protection layers which lie beneath the surface of the road.

When a vehicle passes over the electrical generation device, the pressure plate is pushed downward by the weight of the vehicle. The downward displacement of the pressure plate is used to drive an electrical generator. The electricity generated is then transmitted to a power grid, or collected and stored until it is required by an end user.

An advantage of the present invention is that it is capable of producing very large amounts of electricity without increasing the consumption of any fuel.

Another advantage of the present invention is that it is relatively inexpensive and easy to install.

These and other objects and advantages of the present invention will become apparent to those skilled in the art in view of the description of the best presently known mode of carrying out the invention as described herein and as illustrated in the drawings.

### BRIEF DESCRIPTION OF THE DRAWINGS

FIG. 1 is a partially sectioned view of the device according to the present invention installed under a roadbed.

FIG. 2 is a front detail view of the electrical generator mechanism of the present invention.

FIG. 3 is a rear detail view of the electrical generator mechanism of the present invention.

FIG. 4 is a left side view of the drive wheel gearing mechanism.

FIG. 5 is a right side view of the drive wheel gearing mechanism.

FIG. 6 shows a rendition of the device as installed in an existing road.

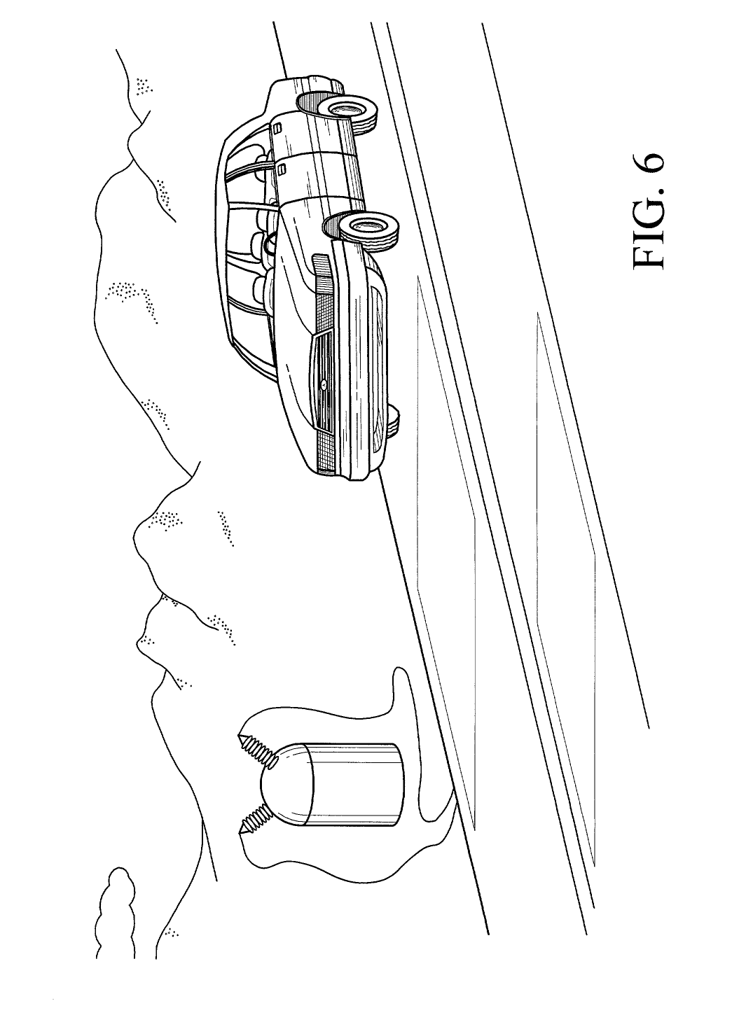

### DETAILED DESCRIPTION OF THE INVENTION

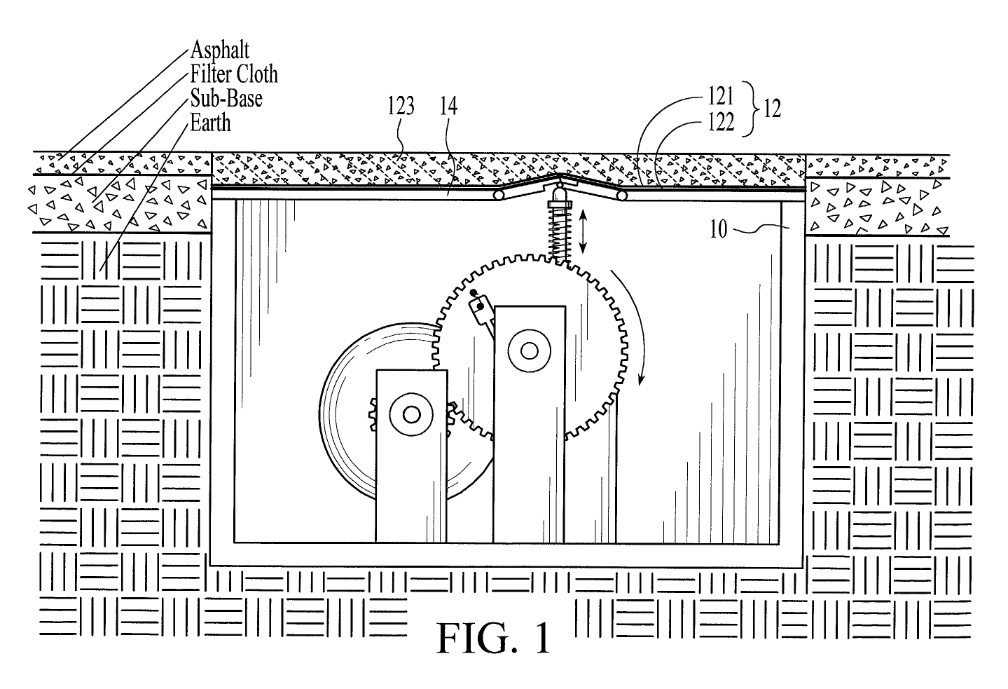

Referring first to FIG. 1, the present invention is a method of electrical power generation that utilizes traffic on existing roadways to generate the electricity. The method makes use of an electrical generation device 1 installed beneath a roadbed 2. The electrical generation device 1 comprises a housing 10 covered with one or more protective layers 12 which lie beneath the surface of the road 2. In the preferred embodiment, the protective layers 12 include at least a filter cloth layer 121 and a rubber sheet 122.

The housing 10 includes in a top section thereof a pressure plate 14. The pressure plate 14 is situated so as to be depressed when a vehicle passes over the pressure plate 14 on the roadway 2. The depression of the pressure plate 14 is the source of the motive power for the electrical generation device 1.

In the preferred embodiment, the pressure plate 14 comprises a pair of end segments 141 that are pivotally attached to the housing 10. An expansion joint 142 in the mid-region of the pressure plate 14 allows the two end segments 141 to move together as the pressure plate 14 is depressed.

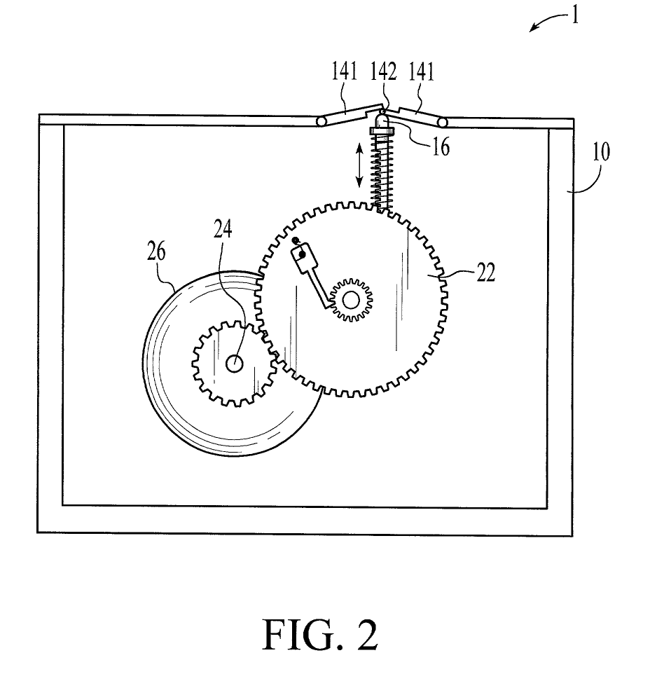

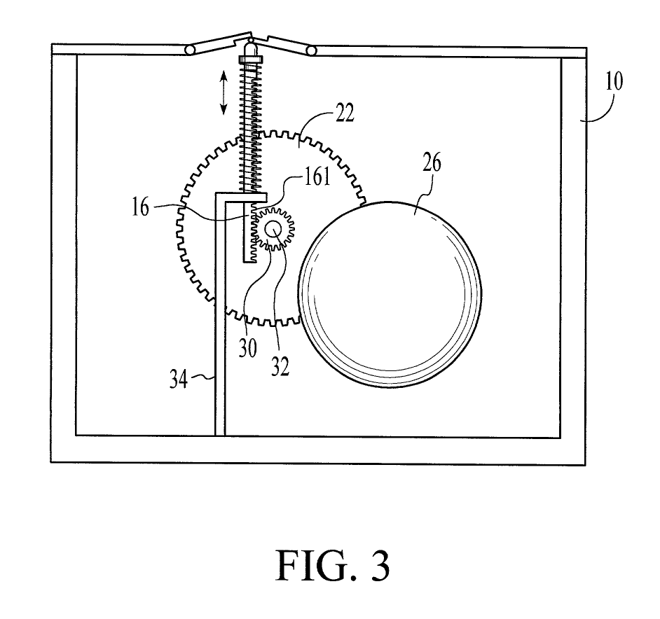

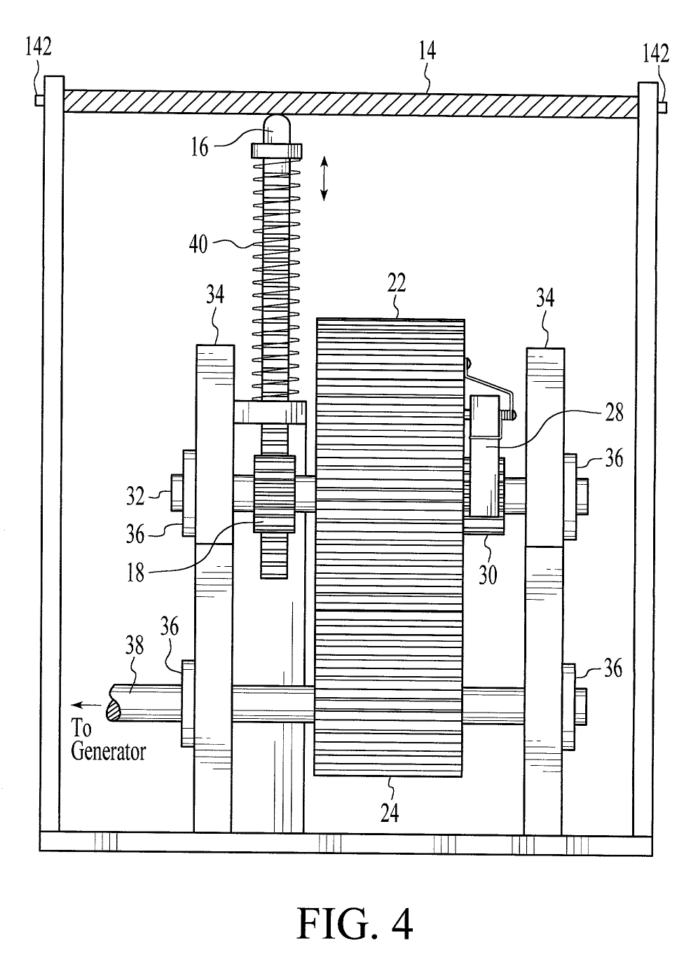

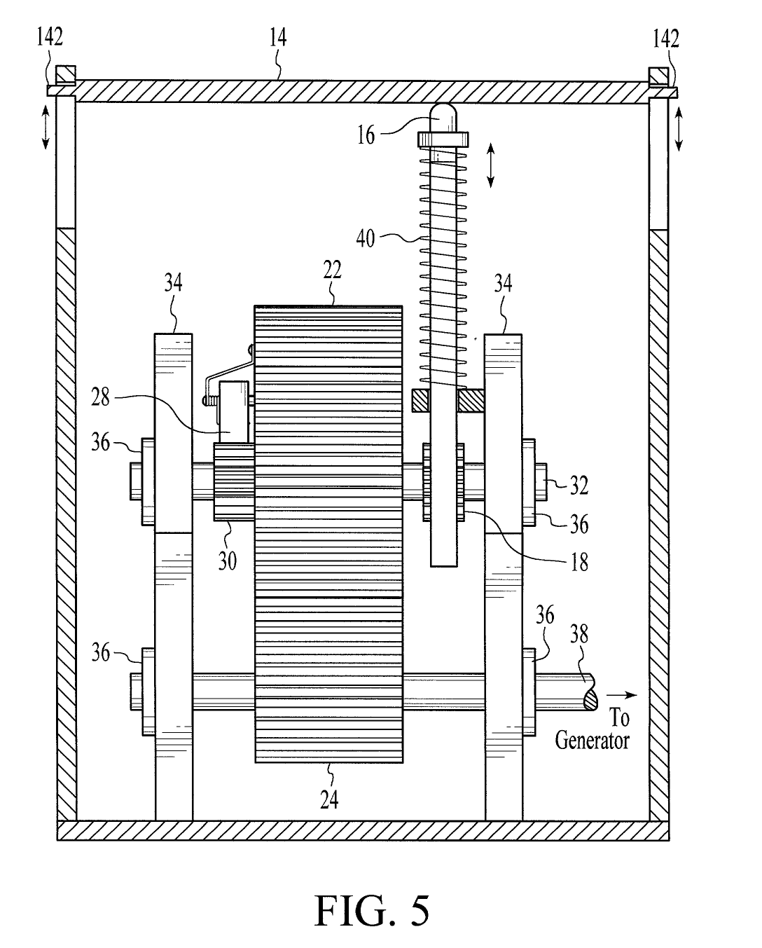

Referring now to FIGS. 2-5, as the pressure plate 14 is moved downward by the weight of the passing vehicle, a rack 16 is driven downward by the pressure plate 14. The rack 16 has a plurality of teeth 161 that turn a pinion gear 18. The pinion 18 is fixedly mounted on a first axle 32 which is supported in a mounting frame 34. The first axle 32 rotates in bearings 36. A flywheel 22 is rotatably mounted on the first axle 32, and a ratchet gear 30 is fixedly mounted on the first axle near the flywheel 22. As the pinion 16 rotates, the ratchet gear 30 also rotates, and drives the flywheel 22 through a spring biased pawl 28.

The flywheel 22 is meshed with a drive wheel 24, which is independently mounted on a second axle 38 in the mounting frame 34. The second axle 38 also serves as the drive shaft for the electrical generator 26. Thus the rotation of the flywheel 22 is communicated to the electrical generator 26 through the drive wheel 24. Electrical generators are well known in the art, and the electrical generator employed in the present invention can be of many known constructions. The construction of the electrical generator 26 is thus not discussed in detail herein.

When pressure on the pressure plate 14 is released, a return mechanism 40 returns the rack 16 to its original raised position. In the preferred embodiment of the electrical generation device 1, the return mechanism 40 is a spring. As the rack 16 is raised, the direction of rotation of the first axle is reversed, and the pawl 28 releases the ratchet gear 30. This allows the flywheel 22 to continue to rotate in its original direction.

Operation of the device is therefore as follows: The pressure plate 14 is moved downward by the weight of a vehicle passing on the road 2. The pressure plate 14 moves a rack 16 downward. Teeth 161 on the rack 16 engage and turn a pinion 18. The pinion 18 is meshed with a flywheel 22, and therefore rotation of the pinion 18 causes the flywheel 22 to rotate. As the flywheel 22 turns, it drives a drive wheel 24 of an electrical generator 26. After the weight of the vehicle is release by the car continuing on its way, a return mechanism 40 restores the rack 16 to its original raised position, where it is ready to again be driven downward by the next passing vehicle.

The above disclosure is not intended as limiting. Those skilled in the art will readily observe that numerous modifications and alterations of the device may be made while retaining the teachings of the invention. In particular, although the method has been described as utilizing a roadway, any location that is subject to traffic, e.g. a parking lot, would be a suitable location for an installation of the device. Moreover, the device could quite easily be modified to be installed in a railroad bed as well.

It should of course also be recognized that the gearing arrangement disclosed herein is but one means of accomplishing the method of the present invention. Any arrangement that provides a large mechanical advantage to translate a short but powerful linear motion into rotational energy could be utilized in the electrical generation device of the present invention.

Accordingly, the above disclosure should be construed as limited only by the restrictions of the appended claims.

I claim:

1. A method of electrical power generation comprising the following steps:
a) installing a pressure plate beneath a roadway in a path of vehicle traffic,
b) constructing said pressure plate such that said pressure plate is depressed when a vehicle passes over said pressure plate,
c) placing said pressure plate in communication with a gearing mechanism, said gearing mechanism translating a linear movement of said pressure plate into rotational movement, and
d) transmitting said rotational movement to a drive shaft of an electrical generator to generate electricity.

2. The method of claim 1 wherein:
said gearing mechanism supplies a multiplying mechanical advantage in translating said linear movement of said pressure plate into said rotational movement.

3. The method of claim 1 wherein:
said gearing mechanism comprises a rack and pinion.

4. The method of claim 1 wherein:
said gearing mechanism comprises a flywheel that is caused to rotate by said rotational movement, and said flywheel drives said drive shaft of said electric generator.
